(19) United States
(12) Patent Application Publication
(10) Pub. No.: US 2024/0309219 A1
(43) Pub. Date: Sep. 19, 2024

(54) PROCESS FOR THE PRODUCTION OF A MULTILAYER COATED SURFACE AND A PRODUCT CONTAINING A MULTILAYER COATED SURFACE

(71) Applicant: SCHATTDECOR SP. Z.O.O., Tarnowo Podgorne (PL)

(72) Inventors: Jerzy SZEJWIAN, Tarnowo Podgorne (PL); Michal SMUS, Tarnowo Podgorne (PL); Krzysztof KONIECZNY, Tarnowo Podgorne (PL); Mateusz NOWAK, Tarnowo Podgorne (PL)

(21) Appl. No.: 18/264,937

(22) PCT Filed: Sep. 1, 2022
(86) PCT No.: PCT/PL2022/050003

§ 371 Date: Aug. 10, 2023

(30) Foreign Application Priority Data
Feb. 24, 2021 (PL) P.437098

(51) Int. Cl. C09D 5/00; A47B 96/20; C09D 4/06; C09D 7/40; C09D 7/42; C09D 7/61; C09D 7/65; C09D 123/06

(52) U.S. Cl. CPC C09D 5/002; A47B 96/206; C09D 4/06; C09D 7/42; C09D 7/61; C09D 7/65; C09D 7/69; C09D 123/06

(57) ABSTRACT

The method according to the invention consists in that the carrier is covered with at least two varnished layers, the two layers being made of electron curable varnishes, which may contain an additive increasing adhesion between the layers, and if the layer which is applied first, counting from the side of the carrier, containing an interlayer adhesion increasing additive, is irradiated with an excimer lamp and then pre-polymerized by electron radiation or UV light, then after applying the second layer also containing an interlayer adhesion increasing additive, the combined layers are cured by electron radiation or UV light. On the other hand, if the layer applied first, counting from the carrier side, is only pre-polymerized by electron radiation or UV light, then after applying the second layer, which then contains an additive increasing adhesion between the layers, it is subjected to irradiation by an excimer lamp and then the combined layers are cured by electron radiation or UV light. As a result, it is possible to obtain a product whose layer refined with excimer lamp and the layer only cured with electron radiation or UV light, are bound together regardless of the order of their occurrence.

The subject-matter of the invention is a method for the production of a multilayer coated surface and a product containing a multilayer coated surface on carriers such as paper films or plastic carriers, in particular BOPP, COPP, PVC, PET or wood-based boards.

The invention can be applied for the production of furniture surfaces. It can also be used to provide structure in the production of melamine surfaces.

Decorative coated materials used on furniture surfaces are paper or plastic foils, unprinted or printed by means of intaglio, flexographic or digital printing, etc., covered with colourless or colour coating.

The invention US2015354132A1 describes a sheet material comprising at least one base layer comprising linoleum or cork lining and a methacrylate-based coating thereon; cured by irradiation using a high energy photon source in combination with a UV lamp.

There are also known methods for obtaining a multi-layer matt coated surface with an improved visual effect due to the difference in gloss between the layers. In the patent application US2020087529A1, the substrate is coated with a first and a second gloss-controlling layer containing a matting agent, for example silica. The matt surface effect is achieved only by using this agent. The layers are double cured, first by ionizing radiation and then by thermal curing.

Another method of producing a multilayer matte surface is described in the application P.426181. It discloses a method and a product obtained by this method, where the matting effect is obtained by refining each applied varnish layer by applying an excimer treatment, and then treating the layers with ultraviolet/electron beam radiation. This allows for a coating with a gloss lower than 6° if it was a single layer of varnish or structure with a gloss of 1°-2° with subsequent coatings. Although electron curable varnishes do not contain separately added matting agents, the surface has a matte effect. In this way, a full matte effect is obtained on the surface.

Surprisingly, it turned out that the application of successive coatings of electron curable varnishes as two top layers, which may also contain matting agents, and subjecting them simultaneously to the irradiation of excimer lamps, allows to obtain a coating and structure with different glosses within one surface.

The main aim is to obtain a surface with a visual effect different from the prior art. Additionally, the method according to the invention allows to combine coatings and structures refined with an excimer with coatings and structures not refined with an excimer. Therefore, each of the product variants always has one layer treated with the excimer and the other only cured with the electron beam, without the mediation of the excimer.

The method according to the invention complements the state of the art with new possibilities of obtaining effective decorative surfaces, including those that require the use of an excimer.

The aim of the invention is to develop a method for the production of multilayer, three-dimensional varnished furniture surfaces, in which at least one varnish layer is refined with excimer lamps and at least one layer is cured without the use of excimer lamps, while any order of the layers refined or unrefined the excimer is allowed. If we refer to the electron curable varnish below, it means a varnish whose polymerization process takes place after the irradiation by an electron beam or UV light. When referring to refining with excimer radiation, it means that the item is irradiated by a xenon excimer lamp emitting light with a wavelength of 172 nanometres. When it comes to electron beam radiation, it is emitted by the electron beam generator both during the initial polymerization process and to complete the polymerization process, i.e. complete curing of the electron curable varnish layers. Alternatively, one can use UV light, which will allow to obtain an adequate pre-polymerization effect or allow to completely cure the electron curable varnish layers.

The essence of the method of producing a multilayer varnished surface on a carrier is that the carrier is covered with at least two varnished layers, the two layers being made of electron curable varnishes, which may contain an additive increasing adhesion between the layers, and if the layer which is applied first, counting from the side of the carrier, containing an interlayer adhesion increasing additive, is irradiated with an excimer lamp and then pre-polymerized by electron radiation or UV light, then after applying the second layer also containing an interlayer adhesion increasing additive, the combined layers are cured by electron radiation or UV light. On the other hand, if the layer applied first, counting from the carrier side, is only pre-polymerized by electron radiation or UV light, then after applying the second layer, which then contains an additive increasing adhesion between the layers, it is subjected to irradiation by an excimer lamp and then the combined layers are cured by electron radiation or UV light.

Preferably, the print layer is applied directly to the carrier prior to the application of the electron or UV curable layers.

It is also advantageous if the layer which is not subjected to the radiation of the excimer lamp is made of an electron curable varnish containing the addition of matting agents.

It is helpful when the additive improving the bond strength of the coating is selected from a group of additives on the basis of micronised wax based on very sensitive polyethylene with an addition of propoxylated glycerol triacrylate.

It is also advantageous to subject the coating to an electronic beam treatment with a dose of 2 to 6 kGy in order to ensure the bond strength between the layers.

It is also advantageous if the varnish is subjected to an electron beam in a dose of 30 to 60 kGy to complete the curing of the electron curable varnish layers.

In addition, it is advantageous if the varnish is exposed to an electron beam at a dose of 60 kGy for complete curing of the electron curable varnish layers.

The essence of a furniture product containing a multilayer varnished surface and a carrier is that it contains at least a carrier covered with a multilayer surface obtained by the method of the invention described above, varnished with at least one type of electron curable varnish, containing an additive improving adhesion between the layers, in the amount of 5 to 30% weight, while the three-dimensional effect of the furniture product results from the structure of the last layer of electron curable varnish.

Preferably, the layer not treated with excimer radiation contains a matting agent with a diameter of 3-11 μm.

In addition, it is preferred that the matting agent is polymethyl methacrylate and/or silica.

It is of advantage, if the carrier material is paper or petroleum-based foil or a wood-based board.

It is also advantageous, if the carrier contains a printed layer.

It is also of advantage, if after hardening to a complete degree of polymerisation, the subsequent layers have a different gloss level.

The desired structure can be obtained on-line, during one passage through the coating machine or the printing and coating machine, or off-line, i.e. with several machines or in several passages through one machine. During the operation of the excimer lamps in the second varnish layer and the applied effects, which only partially covers the first layer, the first layer is also exposed to the excimer lamps. However, this does not affect the structure of the first layer as this is already partially cured (gelled).

The layers refined with the excimer lamps are characterized by a matt surface, and the method of obtaining it does not determine the use of matting agents in the varnish structure. On the other hand, the layers not refined with excimer lamps are characterized by higher gloss surfaces, and the composition of the varnishes used may or may not contain matting agents. If layer 4 is treated with the excimer, then in the two top layers of the electron curable varnish, the varnish composition contains an additive increasing adhesion between the layers, while in a situation where layer 5 is subjected to the treatment by the excimer lamp, then only this layer has an additive increasing the adhesion between the layers.

The above procedures render the final effect of the decorative surface. Depending on the application system, it is possible to obtain, for example, the effect of a matte base with glossy relief elements, or a glossy surface with matte elements of the desired design pattern. Relief elements or designed patterns are created with the use of various intaglio printing cylinders, which also allows to create a three-dimensional effect. However, the method of applying these patterns is not limited to intaglio cylinders. Other possible techniques could be e.g. flexo printing, inkjet (digital) printing or screen printing.

The main advantage of the new product is the possibility of designing decorative surfaces, where the difference in gloss between individual layers of electron-curable varnishes can be much greater than in the prior art. An additional advantage of the surface according to this method is also the haptic effect resulting from the method of obtaining the last layer.

Another advantage is the possibility of combining the layer enriched with the excimer with the layer cured only with electron beam or UV light, regardless of the order of individual layers.

In addition, the method of producing the product is relatively cheaper compared to the prior art due to the cost of a single excimer treatment.

The product and the subject of the invention is schematically shown in the drawing where:

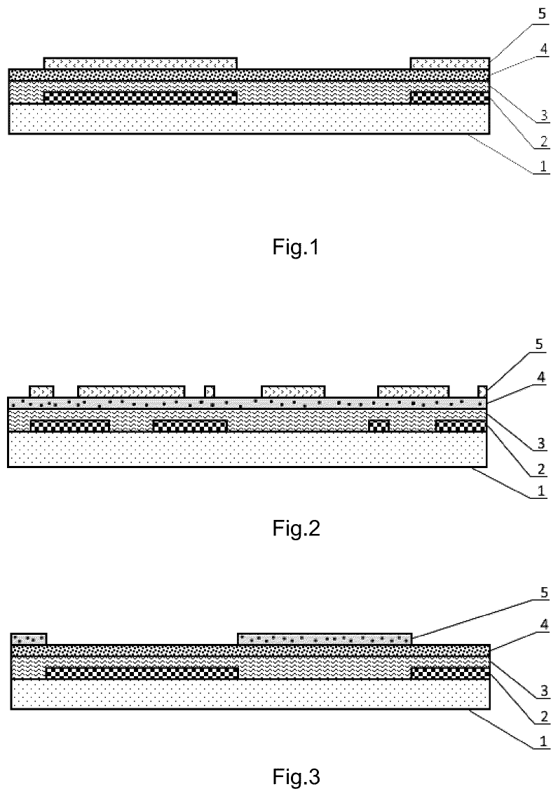

FIG. 1 shows a cross-section of a surface in positive form with a synchronous effect obtained according to the method described in Embodiment 1,

FIG. 2 shows a cross-section of the surface in positive form with asynchronous effect obtained according to the method described in Embodiment 2 or after digital off-line printing as described in Embodiment 5,

FIG. 3 shows a cross-section of a surface in negative form with a synchronous effect obtained according to the method described in Embodiment 3,

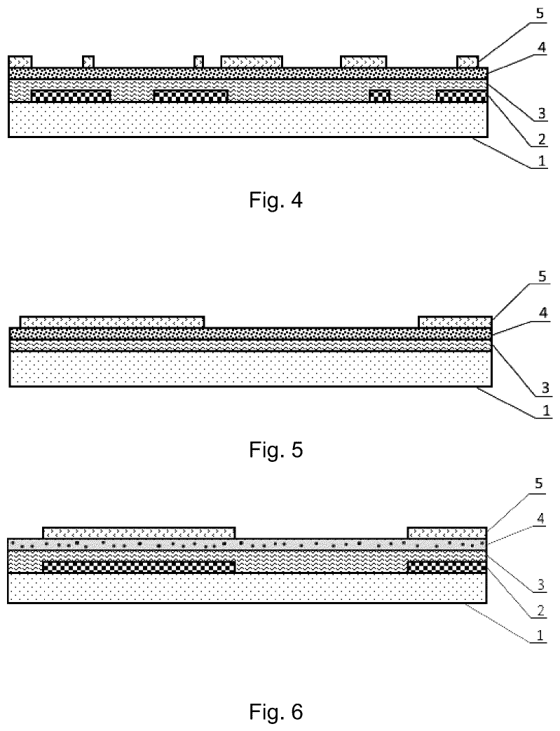

FIG. 4 shows a cross-section of a surface in negative form with asynchronous effect obtained according to the method described in Embodiment 4,

FIG. 5 shows a cross-section of a surface without printing, obtained according to the method described in Embodiment 6,

FIG. 6 shows a cross-section of a surface after digital off-line printing in positive form with a synchronous effect obtained according to the method described in Embodiment 7.

The list of markings in the drawing comprises the markings of individual layers of the decorative surface material in various variants, where 1 is the carrier; 2 is the printed layer (if present in a given variant); 3 is the protective base coat; 4 is the first layer of the electron curable varnish, which may contain an additive to increase the adhesion of the varnish or a matting agent; 5 is the second layer of electron curable varnish with an additive increasing the adhesion of the varnish and may contain a matting agent.

Layers 4 and 5 contain matting agent only if they are not treated with an excimer.

Detailed embodiments of the present invention are disclosed below, however, it may be embodied in various forms. Therefore, the details disclosed herein should not be construed as limiting, but merely as a basis for one skilled in the art how to make and/or use the invention.

Embodiment 1: The process of producing foil with a positive form and a synchronous effect is based on a printing and varnishing machine. The printing stage is performed by a rotating intaglio printing system. A wood-like design pattern 2 is applied onto carrier 1 which is made of paper film band. The design is transferred onto the band by pressing it with a special roller coated with rubber of adequate hardness to the printing cylinder. The cylinder is immersed in a rotating toner container with a feed roller. Excess paint is removed by means of an adjustable scraper blade on the printing cylinder. The band with the paint is then dried in a hot air chamber and afterwards transported to the next printing unit. The carrier passes through three printing stations. Water-soluble paints are used in this process.

The next stage is to coat the substrate with a protective layer 3. This is achieved by means of a special intaglio application cylinder and in this case the primer 3717.212 is applied. The cylinder applies about 6 g/m² of the primer which, like the paint, is cured in a gas dryer at a temperature of 140° C.

The next step is to apply the first layer of electron curable coating 4 by means of a 3WS coating system. At this stage of the process, the coat has the following composition:
FL 27692—0.5 part—polymer resin varnish
FLE 27800—0.5 parts—polymer resin varnish
FZ 2711—0.07 parts—hardener increasing the scratch resistance of the surface
FZ 2720—0.15 parts—additive increasing varnish adhesion

The coating with a weight of 7 g/m² obtained in this way is subjected to an excimer lamp emitting UV light with a wavelength of 172 nm and then to the process of pre-polymerization (gelling) with electron radiation in the electron beam generator. The generator parameter settings are as follows:
Dose 3 kGy
100 kV high voltage

The surface obtained has a gloss of less than 6° when measured with a geometry of 60°.

Then the carrier band is transported to a station with an intaglio cylinder with a synchronous pattern for the different elements of the main design. The varnish is applied to the places that are in line with the design print 2. The structure 5 is imprinted using a coat composed of:
FLE 27800-1 part—polymer resin varnish
FZ2720—0.15 parts—additive increasing varnish adhesion

The surface is cured with electrons in the electron beam generator over the entire thickness of all coat layers. The curing parameter values are:
Dose 60 kGy
110 KV high voltage

The obtained foil, a cross-section of which is presented in FIG. 1, offers, apart from the visual effect of the imprinted design, also a haptic impression. The “porous” structure correlating with the different elements of the main design has a gloss level of 15°-18° measured in a 60° geometry.

The varnish mixture in both application units contains a special additive improving the bond strength between the individual layers. The additional condition for achieving good bond strength is that the coatings are subjected to a preliminary polymerisation (gelling) of the varnish layer at the stage of the production of the first surface coating.

Embodiment 2: To obtain a foil with a positive form and asynchronous effect, design pattern 2 and the protective base coat 3 are applied to the paper-film web carrier 1 in the same manner as shown in Embodiment 1. The next step is to apply the first layer of electron curable coating 4 by means of a 3WS coating system. In this part of the process, the varnish contains a matting agent and has the following composition:
SD 70—8638—0.7 parts—0.2% silica
SD 70—8636—0.3 parts—31% polyacrylate and 1.5% silica

The resulting 8 g/m² coating is pre-polymerized (gelled) in the electron beam generator. The generator parameter settings are as follows:
Dose 3 kGy
100 kV high voltage

The obtained surface has a gloss level of 12°-15° measured in a 60° geometry.

Then the carrier band is transported to a station with an intaglio cylinder with an asynchronous pattern for the different elements of the main design. The varnish is applied in places that partially overlap the print of the design pattern 2 and partially cover the places where the print of the design pattern was not applied. The structure 5 is imprinted using a coat composed of:
FLE 27800-1 part—polymer resin varnish
FZ 2720—0.15 parts—additive increasing varnish adhesion

The surface is exposed to an excimer lamp and then cured with electrons in an electron beam generator over the entire thickness of all the coat layers. The curing parameter values are:
Dose 60 kGy
110 KV high voltage

The obtained foil, a cross-section of which is presented in FIG. 2, offers, apart from the visual effect of the imprinted design, also a haptic impression. The “porous” structure not correlating with the different elements of the main design has a gloss level of 1-2° measured in a 60° geometry.

The varnish mixture in layer 5 contains a special additive that increases adhesion to layer 4. The additional condition for achieving good bond strength is that the coatings are subjected to a preliminary polymerisation (gelling) of the varnish layer at the stage of the production of the first surface coat.

Embodiment 3: To obtain a foil with a negative form and synchronous effect, design pattern 2 and the protective varnish 3 are applied to the plastic film web carrier 1 in the same manner as shown in Embodiment 1.

The next step is to apply the first layer of electron curable coating 4 by means of a 3WS coating system. At this stage of the process, the coat has the following composition:
FLE 27800-1 part—polymer resin varnish
FZ 2720—0.15 parts—additive increasing varnish adhesion

The obtained coating with a grammage of 8 g/m² is exposed to an excimer lamp and then a preliminary polymerisation process (gelling) in an electron beam generator. The generator parameter settings are as follows:
Dose 3 kGy
100 kV high voltage

After this stage, a surface is obtained with a gloss of 1°-2° measured in the geometry of 60°.

The next step in the production process is to apply the synchronous structure 5 to the different elements of the main design. The varnish is applied with a negative cylinder in places that were not previously covered by the design pattern print 2.

In this part of the process, the varnish contains a matting agent and has the following composition:
SD 70—8788—0.65 parts—contains 0.2% silica
SD 70—8704—0.35 parts—contains 30% polyacrylate and 0.2% silica
FZ 2720—0.15 parts—additive increasing varnish adhesion

The surface is cured with electrons in the electron beam generator over the entire thickness of all coat layers. The curing parameter values are:
Dose 60 kGy
110 KV high voltage

The layer of cured coating applied with a negative intaglio cylinder has a gloss level of 12°-15° measured in a 60° geometry. The cross-section of this type of foil is shown in FIG. 3.

The varnish mixture in both application units contains a special additive improving the bond strength between the individual layers. The additional condition for achieving good bond strength is that the coatings are subjected to a preliminary polymerisation (gelling) of the varnish layer 4 at the stage of the production of the first surface coat.

Embodiment 4: To obtain a foil with a negative form and asynchronous effect, design pattern 2 and the protective varnish 3 are applied to the paper-film carrier 1 in the same manner as shown in Embodiment 1.

The first layer of electron curable varnish 4 is applied with the 3WS coating system. At this stage of the process, the coat has the following composition:
FL 27692—0.5 part—polymer resin varnish
FLE 27800—0.5 parts—polymer resin varnish

The resulting coating is subjected to a preliminary polymerization (gelling) process in the electron beam generator. The generator parameter settings are as follows:
Dose 3 kGy
100 kV high voltage

After this stage, a surface is obtained with a gloss of 27°-30° measured in the geometry of 60°.

The next step in the production process is to apply the asynchronous structure 5 to the individual elements of the main wood-like design 2. The varnish is applied in places that partially overlap the print of the design pattern 2 and partially cover the places where the print of the design pattern was not applied.

A pattern is printed with the use of varnish with the following composition:
FL 27692—0.5 part—polymer resin varnish
FLE 27800—0.5 parts—polymer resin varnish
FZ 2720—0.15 parts—additive increasing varnish adhesion

The surface is exposed to excimer lamps and then cured by means of electrons in an electron beam generator over the entire thickness of all coat layers. The curing parameter values are:
Dose 60 kGy
110 KV high voltage

The layer of cured coating applied with a negative intaglio cylinder has a gloss level of 3°-4° measured in a 60° geometry. The cross-section of this type of foil is shown in FIG. 4.

The varnish mixture in layer 5 contains a special additive that increases adhesion to layer 4. The additional condition for achieving good bond strength is that the coatings are subjected to a preliminary polymerisation (gelling) of the varnish layer 4 at the stage of the production of the first surface coat.

Embodiment 5: off-line varnished surface with positive form with asynchronous effect is obtained by applying design pattern 2 to a paper film carrier 1 and a protective base coat 3 in the same manner as shown in Embodiment 1.

In the next technological cycle, the first layer of electron curable varnish 4 is applied using the 3WS coating system. In this part of the process, the varnish contains a matting agent and has the following composition:
SD 70—8638—0.7 parts—0.2% silica
SD 70—8636—0.3 parts—31% polyacrylate and 1.5% silica

The resulting 8 g/m² coating is pre-polymerized (gelled) in the electron beam generator. The generator parameter settings are as follows:
Dose 3 kGy
100 kV high voltage

The obtained surface has a gloss level of 12°-15° measured in a 60° geometry.

In the next off-line technological cycle the asynchronous structure 5 is applied on another coating machine to the different elements of the wood-like design which constitutes layer 2. The varnish is applied in places that partially overlap the print of the design pattern 2 and partially cover the places where the print of the design pattern was not applied.

The structure is imprinted using a coat composed of:
FLE 27800-1 part—polymer resin varnish
FZ 2720—0.15 parts—additive increasing varnish adhesion

The surface is exposed to an excimer lamp and then cured with electrons in an electron beam generator over the entire thickness of all the coat layers.

The curing parameter values are:
Dose 60 kGy
110 KV high voltage

The obtained foil, a cross-section of which is presented in FIG. 2, offers, apart from the visual effect of the imprinted design, also a haptic impression. The “porous” structure not correlating with the different elements of the main design 2 has a gloss level of 1-2° measured in a 60° geometry.

The varnish mixture in layer 5 contains a special additive that increases adhesion to layer 4. The additional condition for achieving good bond strength is that the coatings are subjected to a preliminary polymerisation (gelling) of the varnish layer at the stage of the production of the first surface coat.

Embodiment 6: A protective base coat 3 consisting of Primer 3717.212 is applied to the carrier 1 consisting of paper film in the same manner as described in example 1a.

The next step is to apply the first layer of electron curable coating 4 by means of a 3WS coating system. At this stage of the process, the coat has the following composition:
FL 27692—0.5 part—polymer resin varnish
FLE 27800—0.5 parts—polymer resin varnish
FZ 2711—0.07 parts—hardener increasing the scratch resistance of the surface
FZ 2720—0.15 parts—additive increasing varnish adhesion

The obtained coating with a grammage of 7 g/m² is exposed to an excimer lamp and then a preliminary polymerisation process (gelling) in an electron beam generator. The generator parameter settings are as follows:
Dose 3 kGy
100 kV high voltage

The obtained surface has a gloss level below 6° measured in a 60° geometry.

The carrier web then advances to the intaglio cylinder station with an ornamental decorative pattern. The structure 5 is imprinted using a coat composed of:
FL 27692—0.5 part—polymer resin varnish
FLE 27800—0.5 parts—polymer resin varnish
FZ2720—0.15 parts—additive increasing varnish adhesion

The surface is cured with electrons in the electron beam generator over the entire thickness of all coat layers. The curing parameter values are:
Dose 60 kGy
110 KV high voltage

In addition to the visual effect, the resulting foil with cross-section shown in FIG. 5, also offers a haptic impression. The applied structure has a gloss level of 25°-28° measured in a 60° geometry.

The varnish mixture in both application units contains a special additive improving the bond strength between the individual layers. The additional condition for achieving good bond strength is that the coatings are subjected to a preliminary polymerisation (gelling) of the varnish layer at the stage of the production of the first surface coat.

Embodiment 7: The first layer of electron curable varnish coat 4 is applied by means of a 3WS coating system to the carrier 1 previously imprinted with the design pattern 2 by means of a PALIS digital printer with a protective coat of electron curable primer. In this part of the process, the varnish contains a matting agent and has the following composition:
SD 70—8638—0.7 parts—0.2% silica
SD 70—8636—0.3 parts—−31% polyacrylate and 1.5% silica

The resulting 8 g/m² coating is pre-polymerized (gelled) in the electron beam generator. The generator parameter settings are as follows:
Dose 3 kGy
100 kV high voltage

The obtained surface has a gloss level of 12°-15° measured in a 60° geometry.

In the next technological cycle, a synchronous structure 5 is applied to the individual elements of the wood-like design pattern 2. The varnish is applied to the places that are in line with the design print 2.

The structure 5 is imprinted using a coat composed of:
FLE 27800-1 part—polymer resin varnish
FZ 2720—0.15 parts—additive increasing varnish adhesion

The surface is exposed to an excimer lamp and then cured with electrons in an electron beam generator over the entire thickness of all the coat layers. The curing parameter values are:
Dose 60 kGy
110 KV high voltage

The obtained foil, a cross-section of which is presented in FIG. 6, offers, apart from the visual effect of the imprinted design, also a haptic impression. The “porous” structure not correlating with the different elements of the main design 2 has a gloss level of 1-2° measured in a 60° geometry.

The varnish mixture in layer 5 contains a special additive that increases adhesion to layer 4. The additional condition for achieving good bond strength is that the coatings are subjected to a preliminary polymerisation (gelling) of the varnish layer at the stage of the production of the first surface coat.

Regarding the embodiments described above, the use of electron curable varnishes with the addition of matting agents allows to obtain glosses in the range of 10°-40° for smooth surfaces, while for structured surfaces the gloss can be reduced to 4°-5°. The varnishes marked FL/FLE, on the other hand, are Hesse varnishes mainly used in the refinement by excimer lamps. These varnishes guarantee the cured surfaces with a gloss of 1°-6° (practically 1°-10°), when refined with excimer lamps, or glosses in the range of 10°-30° when curing the surface with electron beam/UV light. The use of the above-mentioned varnishes in various combinations renders a product with different effects. The large difference in the gloss of the layers 4 and 5 makes it possible to obtain a product with a completely different effect than in the prior art. All the embodiment show just such a surface, where the coating 4 and the structure 5 have a gloss varying from a few to several degrees.

1. A method of producing a multilayer matt varnished surface on a carrier, refined on machines for the application of electron or UV light curable varnish, where the carrier is coated with a layer of varnish containing an additive increasing the adhesion of varnish between layers, in the coating system characterized in that the carrier (1) is coated at least two layers of varnish, where two layers (4, 5) are made of electron curable varnishes that may contain an additive increasing adhesion between the layers, and if the layer (4) applied first, counting from the carrier side, containing an additive increasing adhesion between the layers is subjected irradiated by an excimer lamp and then pre-polymerization with electron radiation or UV light, then after applying the second layer (5) also containing an additive increasing adhesion between the layers, the combined layers are cured by electron radiation or UV light, and if the layer (4) applied first counting from the carrier side, is only pre-polymerized by electron radiation or UV light, then after applying the second layer (5), which then contains an additive increasing adhesion between the layers, it is irradiate by an excimer lamp and then the combined layers are cured by electron radiation or UV light.

2. A method according to claim 1 characterized in that the print layer (2) is applied directly to the carrier (1) prior to the application of the electron or UV curable layers (4, 5).

3. A method according to claim 1 characterized in that the layer (4, 5) which is not irradiated by the excimer lamp is made of an electron curable varnish containing the addition of matting agents.

4. A method according to claim 1 characterised in that the additive improving the bond strength of the coating is selected from a group of additives developed on the bases of micronised waxes based on very sensitive polyethylenes with the addition of propoxylated glycerol triacrylate.

5. A method according to claim 1 characterised in that in order to improve adhesion between the layers, the varnish is irradiated with an electron beam with a dose from 2 to 6 kGy.

6. A method according to claim 1 characterised in that in order to fully cure the electron curable varnish layers, they are irradiated with an electron beam with a dose from 30 to 60 kGy.

7. A method according to claim 6 characterised in that in order to fully cure the electron curable varnish layers, they are irradiated with an electron beam with a dose of 60 kGy.

8. A furniture product containing a multilayer varnished surface and a carrier characterised in that it contains at least a carrier 1 covered with a multilayer surface obtained by the method of claim 1, varnished with at least one type of electron curable varnish, containing an additive improving adhesion between the layers, in the amount of 5 to 30% weight, while the three-dimensional effect of the furniture product results from the structure of the last layer of electron curable varnish.

9. The product according to claim 8, characterized in that the layer not treated with excimer radiation contains a matting agent with a diameter of 3-11 μm.

10. The product according to claim 9, characterised in that the matting agent is polymethyl methacrylate and/or silica.

11. Product according to claim 8, characterised in that the carrier (1) is paper or petroleum-based foil or a wood-based board.

12. Product according to claim 8, characterised in that the carrier (1) contains an imprinted layer (2).

13. Product according to claim 8, characterised in that the following layers (4, 5) that are cured to a complete degree of polymerisation, have a different gloss level.
